(19) United States
(12) Patent Application Publication
(10) Pub. No.: US 2017/0077861 A1
(43) Pub. Date: Mar. 16, 2017

(54) Step-Up Power Transformer with Integral Sine-Wave Filter for PWM Inverters

(71) Applicant: GE Oil & Gas ESP, Inc., Oklahoma City, OK (US)

(72) Inventor: Donald Matthew Dowhower, Oklahoma City, OK (US)

(73) Assignee: GE Oil & Gas ESP, Inc., Oklahoma City, OK (US)

(21) Appl. No.: 15/261,499

(22) Filed: Sep. 9, 2016

Related U.S. Application Data
(60) Provisional application No. 62/217,665, filed on Sep. 11, 2015.

(51) Int. Cl. H02P 27/08; E21B 43/12; H02K 5/132

(52) U.S. Cl. CPC H02P 27/08; H02K 5/132; E21B 43/128

(57) ABSTRACT

A pumping system includes an electric motor, a power supply, a variable speed drive connected to the power supply, a transformer connected to the variable speed drive and a power cable connected between the transformer and the electric motor. The transformer includes a sine-wave filter that has inductors contained within an oil-filled central tank.

### RELATED APPLICATIONS

This application claims the benefit of U.S. Provisional Patent Application Ser. No. 62/217,665 entitled “Step-Up Power Transformer with Integral Sine-Wave Filter for PWM Inverters,” filed Sep. 11, 2015, the disclosure of which is herein incorporated by reference.

### FIELD OF THE INVENTION

This invention relates generally to the field of pumping systems with electric motors, and more particularly, but not by way of limitation, to an improved transformer for providing power to the pumping system.

### BACKGROUND

Pumping systems are often deployed into wells to recover petroleum fluids from subterranean reservoirs. Typically, the submersible pumping system includes a number of components, including one or more electric motors coupled to one or more high performance pumps. Each of the components and sub-components in a submersible pumping system is engineered to withstand the inhospitable downhole environment, which includes wide ranges of temperature, pressure and corrosive well fluids.

The electric motor is often driven by a variable speed drive located on the surface. The variable speed drive produces an alternating current that is transferred to the electric motor through a power cable. In some applications, the voltage of the current provided by the variable speed drive must be increased to reach the design voltage for the electric motor. Sine-wave, low pass filters may be used to reduce unwanted portions of the waveform produced by the variable speed drive.

In the past, the sine-wave filters have been installed inside the cabinet of the variable speed drive. The inductors of the sine-wave filter may produce heat during operation and the enclosure must be modified to accommodate the cooling requirements for the sine-wave filter. Modifying the cabinet of the variable speed drive to accommodate the cooling requirements of the sine-wave filter is problematic for several reasons. First, it may be difficult to achieve NEMA-4 qualification for the cabinet of the variable speed drive if the cabinet must be configured to provide suitable airflow to cool the sine-wave filter. Second, the need to modify a variable speed drive to accommodate a sine-wave filter presents a manufacturing problem because multiple versions of a single variable speed drive must be produced. It is to these and other deficiencies in the prior art that the present invention is directed.

### BRIEF DESCRIPTION OF THE DRAWINGS

FIG. 1 is a perspective view of a pumping system constructed in accordance with an exemplary embodiment.

FIG. 2 is a functional depiction of the transformer from the pumping system of FIG. 1.

### WRITTEN DESCRIPTION

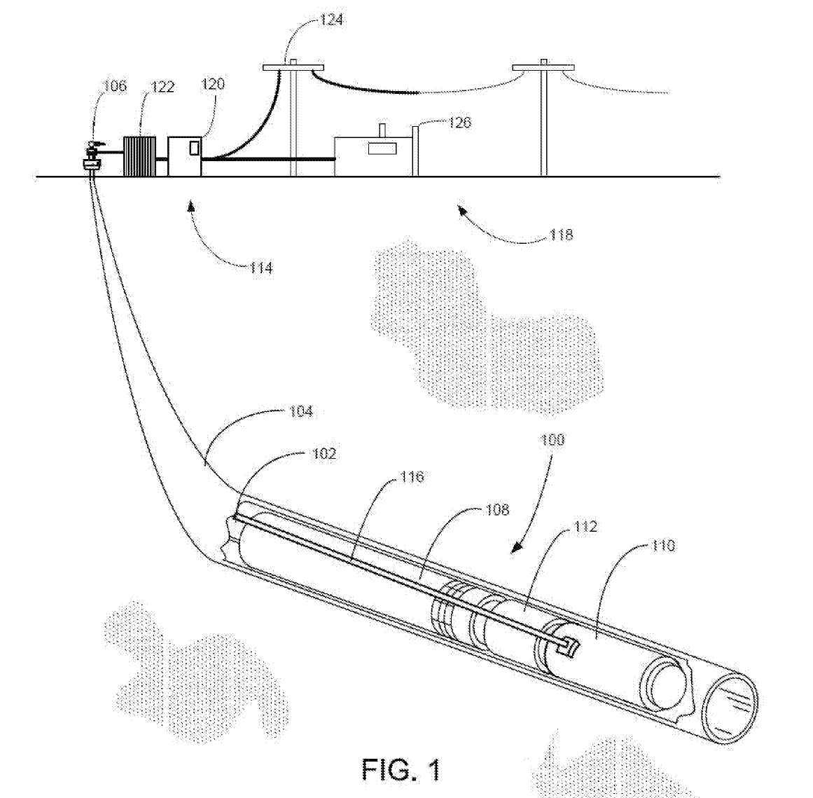

In accordance with exemplary embodiments of the present invention, FIG. 1 shows a perspective view of a pumping system 100 attached to production tubing 102. The pumping system 100 and production tubing 102 are disposed in a wellbore 104, which is drilled for the production of a fluid such as water or petroleum. As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move other fluids. It will also be understood that, although the pumping system 100 of FIG. 1 is depicted in a deviated or non-vertical wellbore 104, the pumping system 100 and methods disclosed herein will find also utility in traditional vertical wellbores.

The pumping system 100 includes a pump 108, a motor 110 and a seal section 112. The motor 110 is an electric motor that receives power from surface facilities 114 through a power cable 116. When energized, the motor 110 drives a shaft (not shown) that causes the pump 108 to operate. The seal section 112 shields the motor 110 from mechanical thrust produced by the pump 108 and provides for the expansion of motor lubricants during operation. The seal section 112 also isolates the motor 110 from the wellbore fluids passing through the pump 108.

The surface facilities 114 provide power and control to the motor 110. The surface facilities 114 include a power source 118, a variable speed drive (VSD) 120 and a transformer 122. The power source 118 includes one or both of a public electric utility 124 and an independent electrical generator 126. Electricity is fed by the power source 118 to the variable speed drive 120.

During normal operation, the variable speed drive 120 produces a low voltage, pulse width modulated (PWM) current at a selected frequency. The waveform produced by the variable speed drive 120 can be adjusted manually or automatically to adjust the operating parameters of the pumping system 100. The output of the variable speed drive 120 is provided to the transformer 122, where the voltage is modified to the design voltage range of the motor 110.

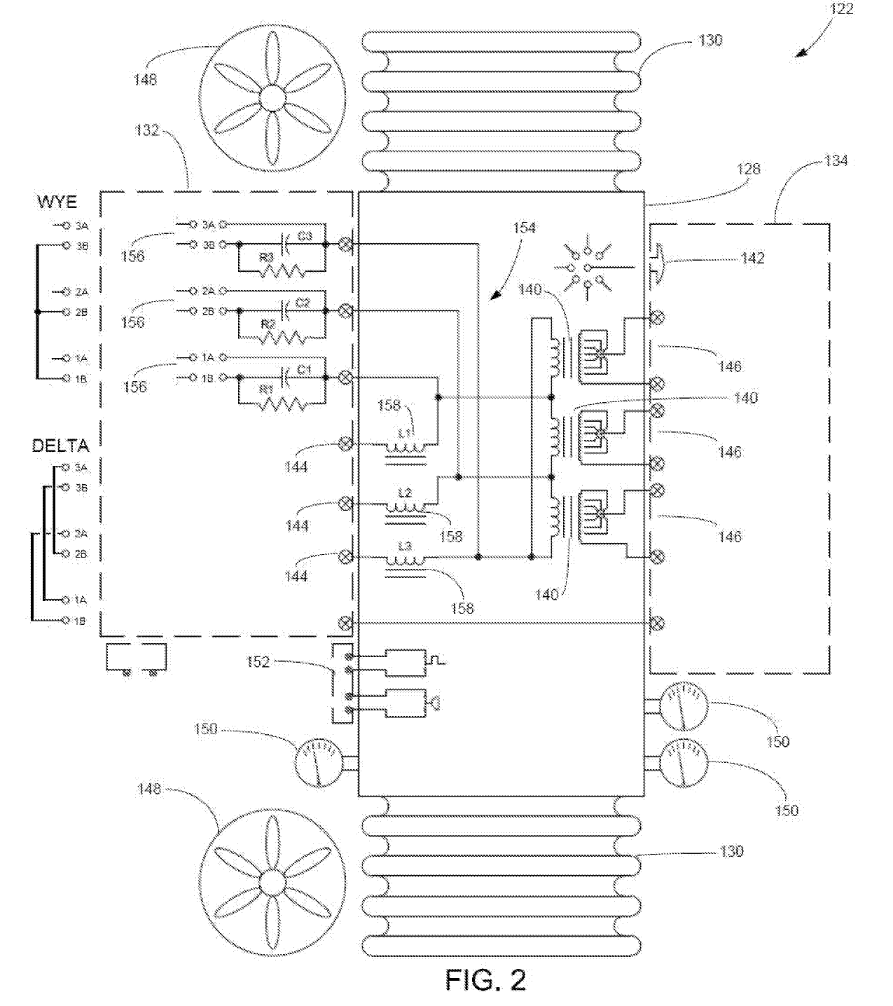

Turning to FIG. 2, shown therein is a diagrammatic depiction of the transformer 122 constructed in accordance with exemplary embodiments. The transformer 122 includes a central tank 128, cooling fins 130, an input throat 132 and an output throat 134. The input throat 132 and output throat 134 can be in a common or separate junction box to accommodate aspects of safety, component space, and/or cost. The central tank 128 includes one or more variable-output step-up transformers 140 that produce an output current with an increased voltage in accordance with established principles of electromagnetic induction. A switch 142 is provided to permit the selection of the desired output from the step-up transformers 140.

Current is fed to the step-up transformers 140 through input connections 144 in the input throat 132. Input wiring to the step-up transformers 140 may be connected as wye (not shown) or delta (shown) connections as required per transformer input design and voltage capacity. The output of the step-up transformers is connected to downstream conduit through output connections 146 in the output throat 134. Output wiring from the step-up transformers 140 may be connected as wye or delta connections as required for proper voltage amplification, and is typically performed with external straps at output connections 146. The power cable 116 may be directly or indirectly connected to the output connections 146 in the output throat 134.

The central tank 128 is filled with a dielectric fluid that electrically insulates and cools the components inside the central tank 128. The fluid may be passively or actively pumped through the cooling fins 130 to reduce the temperature of the fluid and thereby cool the internal components within the central tank 128. Fans 148 may be used to increase the exchange of heat through the cooling fins 130. In some applications, it may be desirable to cool the dielectric fluid using external heat exchangers (not shown) in addition to, or as an alternative to, the cooling fins 130. Gauges 150 and sensors 152 may be used to monitor the operating and physical condition of the central tank 128. The gauges 150 and sensors 152 may be configured to measure the temperature, pressure and level of the fluid inside the central tank 128. It will be appreciated that the central tank 128 is substantially sealed to prevent the contamination or leakage of the internal cooling fluid.

The transformer 122 also includes an integral sine-wave filter 154. The sine-wave filter 154 includes a series of resistive-capacitive (RC) circuits 156 and inductors 158. The RC circuits 156 are contained within the input throat 132 and connected via a delta or wye connection. The inductors 158 are housed inside the central tank 128 and connected to the input connection 144 and to the RC circuits 156. The sine-wave filter 154 can be configured as a low-pass filter that removes unwanted effects of the pulse width modulated output from the variable speed drive 120.

In certain applications, it may not be necessary or desirable to use the integral sine-wave filter 154. The sine-wave filter 154 can be easily switched to a dormant, non-functional state by removing the appropriate capacitor connections and placing shorting straps across the corresponding terminals within the input throat 132 to short out the inductors 158. In this way, the standardized transformer 122 that includes the sine-wave filter 154 can be easily configured for applications in which filtering is necessary and unnecessary.

Placing the heat-producing inductors 158 inside the central tank 128 facilitates the cooling of the sine-wave filter 154 by leveraging the existing cooling mechanisms present in the transformer 122. This eliminates the need to incorporate a sine-wave filter within the variable speed drive 120. Placing the sine-wave filter 154 within the transformer 122 makes it easier to achieve NEMA-4 ratings for the sine-wave filter 154 without the need for additional cabinets or cooling solutions.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts and steps within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A pumping system comprising:
an electric motor;
a power supply;
a variable speed drive connected to the power supply;
a transformer connected to the variable speed drive, wherein the transformer includes an internal sine-wave filter; and
a power cable connected between the transformer and the electric motor.

2. The pumping system of claim 1, wherein the transformer comprises:
a central tank;
an input throat; and
an output throat.

3. The pumping system of claim 2, wherein the sine-wave filter comprises one or more resistive-capacitive (RC) circuits and one or more inductors.

4. The pumping system of claim 3, wherein the one or more inductors of the sine-wave filter are contained within the central tank.

5. The pumping system of claim 4, wherein the one or more resistive-capacitive (RC) circuits are contained within the input throat.

6. The pumping system of claim 4, wherein the central tank includes a dielectric cooling fluid.

7. The pumping system of claim 6, wherein the transformer further comprises cooling fins connected to the central tank.

8. A transformer for use in connection with an electric submersible pumping system, the transformer comprising:
a central tank, wherein the central tank contains dielectric cooling fluid;
an input throat;
an output throat; and
a sine-wave filter comprising:
one or more resistive-capacitive (RC) circuits; and
one or more inductors, wherein each of the one or more inductors is contained within the central tank.

9. The transformer of claim 8, wherein each of the one or more resistive-capacitive (RC) circuits are contained within the input throat.

10. The transformer of claim 9, wherein the input throat further comprises a plurality of input connections, wherein each of the plurality of input connections is connected to a separate one of the one or more inductors.

11. The transformer of claim 10, wherein the transformer further comprises one or more step-up transformers.

12. The transformer of claim 11, wherein each of the one or more step-up transformers are contained within the central tank.

13. The transformer of claim 8, wherein the transformer further comprises cooling fins connected to the central tank.

14. A pumping system configured to produce fluids from a wellbore, the pumping system comprising:
an electric motor;
a pump driven by the electric motor;
a power supply;
a variable speed drive connected to the power supply;
a transformer connected to the variable speed drive, wherein the transformer comprises:
a central tank, wherein the central tank contains dielectric cooling fluid;
an input throat;
an output throat; and
a sine-wave filter comprising:
one or more resistive-capacitive (RC) circuits; and
one or more inductors, wherein each of the one or more inductors is contained within the central tank; and
a power cable connected between the transformer and the electric motor.

15. The pumping system of claim 14, wherein each of the one or more resistive-capacitive (RC) circuits are contained within the input throat.

16. The pumping system of claim 15, wherein the input throat further comprises a plurality of input connections, wherein each of the plurality of input connections is connected to a separate one of the one or more inductors.

17. The pumping system of claim 16, wherein the transformer further comprises one or more step-up transformers.

18. The pumping system of claim 17, wherein each of the one or more step-up transformers are contained within the central tank.

19. The pumping system of claim 18, wherein the transformer further comprises cooling fins connected to the central tank.

20. The pumping system of claim 14, wherein the variable speed drive is configured to produce a pulse width modulated (PWM) current at a selected frequency.
